(19) United States
(12) Patent Application Publication
(10) Pub. No.: US 2004/0095247 A1
(43) Pub. Date: May 20, 2004

(54) Moisture sensor, diaper with such a sensor, and method for detecting the presence and/or the intactness of the moisture sensor

(76) Inventors: Peter Hillebrand De Haan, Bs Delft (NL); Gerardus Titus Van Heck, Cs Eindhoven (NL)

Correspondence Address: MUSERLIAN, LUCAS AND MERCANTI, LLP, 475 PARK AVENUE SOUTH, NEW YORK, NY, 10016, US

(21) Appl. No.: 10/344,817

(22) PCT Filed: Aug. 15, 2001
(86) PCT No.: PCT/NL01/00609

(30) Foreign Application Priority Data
Aug. 15, 2000 (NL) 1015940

(51) Int. Cl. G08B 23/00

(52) U.S. Cl. 340/573.5

(57) ABSTRACT

The moisture sensor for detecting moisture comprises at least one first electrode provided with at least one IGP, at least one second electrode and a dielectric included between the first and the second electrode. The dielectric is of a type that can absorb moisture, so that the presence of moisture can be detected on the basis of an electric voltage difference between the first and the second electrode. The first electrode is provided with a ribbon-shaped carrier, to which the at least one IGP is applied.

The invention relates to a moisture sensor for detecting moisture, comprising at least one first electrode provided with an IGP, at least one second electrode and at least one dielectric included between the first and the second electrode, which dielectric is of a type that can absorb moisture, so that the presence of moisture can be detected on the basis of an electric voltage difference between the first and the second electrode.

The invention also relates to a diaper provided with such a moisture sensor.

Furthermore, the invention relates to a method for detecting the presence and/or the intactness of such a moisture sensor. Moreover, the invention relates to a method for determining, by means of the moisture sensor, the amount of moisture and/or determining the sum of the lengths of parts of the first electrode of the moisture sensor that are moist. Besides, the invention relates to a method for determining a place of the moisture on the sensor.

The moisture sensor of the type mentioned in the opening paragraph is known per se. In the known moisture sensor, the second electrode is also provided with an IGP. The first and the second electrode each have the form of a flat layer. This gives the moisture sensor a substantially two-dimensional form.

A drawback of the known moisture sensor is that an area in which moisture can be detected is determined by the predetermined form of the moisture sensor. For areas having dimensions and forms different from each other, therefore, different moisture sensors must be produced.

It is an object of the invention to provide a solution for the above problem. The moisture sensor according to the invention is correspondingly characterized in that the first electrode is provided with a ribbon-shaped carrier, to which the at least one IGP is applied.

Because of the fact that the first electrode is formed by a ribbon-shaped carrier, to which the IGP is applied, this electrode is completely flexible and can be used such that the moisture sensor can detect in a predetermined area. A further advantage is that the sensor can only be made of non-metals.

The first electrode can be laid, for instance, around the relevant area for detection of the moisture. In specific embodiments of the moisture sensor, the two electrodes and the dielectric can be adapted to the manner in which the first electrode is used. Thus, the first electrode can be used according to a straight line. If the second electrode also has an elongated form extending parallel to the first electrode, then moisture detection can then take place, for instance, in the area included between the first and the second electrode. The first electrode, however, may also be arranged in the form of a circle. The second electrode may then, for instance, be included in the area enclosed by the first electrode. Moisture detection can then take place in the area enclosed by the first electrode. Similarly, the first electrode may be used in the form of a square, while the second electrode is arranged in the area enclosed by the first electrode for detecting moisture in the square area. Owing to the fact that the first electrode is formed by a thread or a ribbon-shaped fabric, moisture can therefore be detected with the relevant electrode in an area the dimensions and form of which can be chosen freely. Moreover, the second electrode may have an elongated form extending parallel to the first electrode, while the two electrodes are placed in each other's vicinity such that the moisture sensor has an elongated and flexible form.

A further advantage of the moisture sensor according to the invention is that it can be fitted very easily in any desired product.

In particular, it holds that the thread or the ribbon-shaped fabric comprises polyester. The thread or the ribbon-shaped fabric may, for instance, be coated with the IGP. The IGP may, for instance, comprise polypyrrole.

According to a very advanced embodiment of the invention, it holds that the dielectric comprises a fabric. Such a dielectric has, like the first electrode, a very flexible character, that is to say the form and dimensions can be easily adapted to the desired use of the moisture sensor. It further holds that in particular the second electrode is fitted on the fabric of the dielectric. The second electrode can then extend in a longitudinal direction of the moisture sensor if the dielectric is wound around the first electrode. In particular, it holds that the second electrode is arranged at an edge of the fabric of the dielectric located on the exterior of the moisture sensor.

In particular, it further holds that the fabric of the dielectric is wound around the first electrode. This can ensure that the moisture sensor as a whole is, at least substantially, of ribbon-shaped design. The moisture sensor as a whole therefore has a two-dimensional character. This ensures that the elongated moisture sensor can be used in any desired form for detecting moisture in a predetermined area.

A possible use of the sensor relates to diapers. It for instance, moisture should be detected in a specific area of a diaper, the moisture sensor can be easily fitted around this area for detecting moisture.

In particular, it further holds that a moisture-proof coating is locally applied on an exterior of the fabric of the dielectric for designing the moisture sensor so as to be locally sensitive to moisture. Where the coating is not applied, the sensor is sensitive to moisture.

The second electrode preferably comprises another material than the first electrode. The second electrode preferably comprises graphite. The diaper provided with a moisture sensor according to the invention is further characterized in that the first electrode extends around an area of the diaper where the presence of moisture should be detected, the second electrode is arranged on at least part of the fluff of the diaper in the area or on the coating foil of the diaper in the area, so that the fluff of the area functions as the dielectric.

The method for detecting the presence of moisture and/or the intactness of the moisture sensor is characterized in that the resistance of the two electrodes individually, the direct-current resistance between the electrodes and/or the alternating-current resistance between the electrodes and/or the current through a predetermined resistance included between the first and the second electrode is measured.

The method for determining, by means of the moisture sensor, the amount of moisture and/or determining the sum of the lengths of parts of the first electrode of the moisture sensor that are wet is characterized by measuring the internal resistance between the first and the second electrode, in particular by measuring the short-circuit current.

The method for determining, by means of the moisture sensor, the place of the moisture on the sensor is characterized by determining the ratio between the short-circuit currents measured respectively at two ends of the sensor between the first and the second electrode.

The invention will now be explained in more detail with reference to the drawings in which:

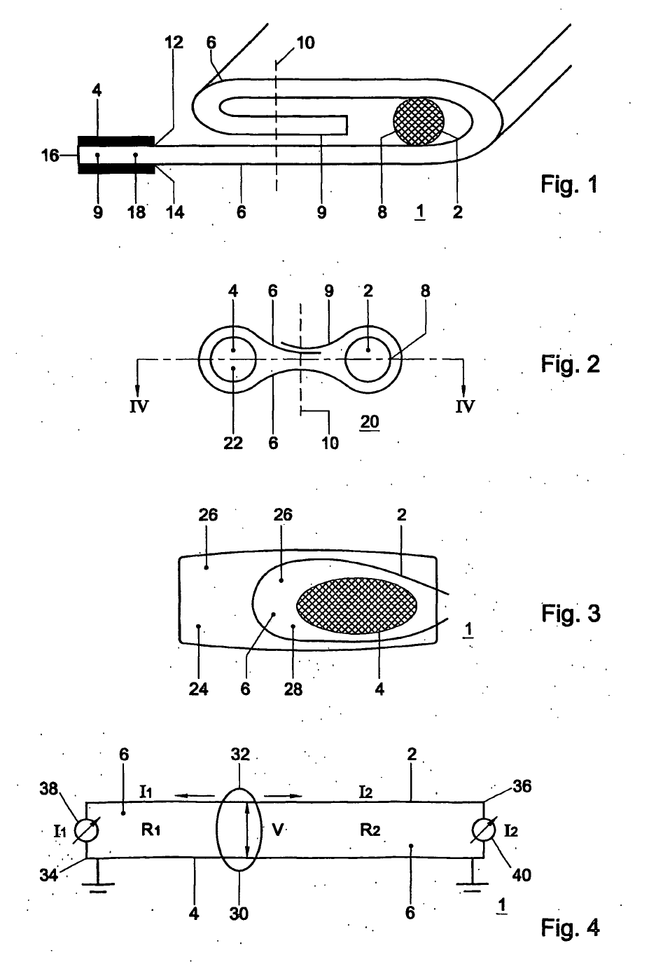

FIG. 1 diagrammatically shows a first embodiment of a moisture sensor according to the invention;

FIG. 2 diagrammatically shows a second embodiment of a moisture sensor according to the invention;

FIG. 3 diagrammatically shows a diaper provided with a moisture sensor according to the invention; and

FIG. 4 diagrammatically shows a third embodiment and a use of the moisture sensor according to the invention.

The moisture sensor 1 comprises a first electrode 2 provided with at least one IGP (intrinsically conducting polymer). Furthermore, the moisture sensor comprises a second electrode 4 and a dielectric 6 included between the first and the second electrode. The dielectric 6 is of a type that can absorb moisture, so that the presence of moisture can be detected on the basis of an electric voltage difference between the first and the second electrode. This involves an electrochemical potential generated by the moisture in the dielectric between the first and the second electrode. More in particular, a possible use of the sensor can be further elaborated according to the following possible measuring principle. An electrolyte is formed when the dielectric 6 becomes moist. The contact between the first electrode 2 and the electrolyte leads to an electrochemical potential between the first electrode and the electrolyte. The contact between the second electrode 4 and the electrolyte leads to an electrochemical potential between the second electrode and the electrolyte. Because the two electrodes 2, 4 are made of, for instance, a different material or are provided with different materials, these electrodes will have a different electrochemical potential. When the resistance of the electrolyte is sufficiently low, the above electric voltage difference arises between the two electrodes. A battery is formed. The height of the potential is only dependent on the material of the two electrodes. This open terminal voltage is, however, independent of the place of moistening of the sensor. The maximum current the thus formed battery can deliver (the short-circuit current) is dependent on the internal resistance of the resulting battery and, thus, on the amount of moisture that has got on the dielectric. The internal resistance is therefore a measure of the amount of moisture and can be measured in a known per se manner. Other measuring methods for the sensor are, however, also possible, as will hereinafter be discussed with reference to a number of examples.

The first electrode 2 comprises a ribbon-shaped carrier 8, to which the IGP is applied. The ribbon-shaped carrier is, in this example, provided with a thread 8, to which the IGP is applied. The thread 8 may, for instance, be a polyester thread or yarn. It is, however, also possible that the ribbon-shaped carrier is provided with a ribbon-shaped fabric, to which the IGP is applied. In this example, the ribbon-shaped carrier is, anyhow, of deformable design. The thread 8 may also be a known per se polyester fabric thread. Even when the ribbon-shaped carrier is designed as a ribbon-shaped fabric, a fabric material is in fact referred to here. Preferably, it therefore holds that the ribbon-shaped carrier is formed by a fabric material.

The thread or the ribbon-shaped fabric may be coated with the above IGP. The at least one IGP may, for instance, be provided with polypyrrole, polytiophene or a derivative thereof and combinations of these materials.

The dielectric 6, in this example, consists of a fabric 9. More in particular, this example relates to a cotton fabric. The cotton fabric, that is to say the dielectric, is preferably treated with an acid buffer solution, so that the IGP can properly function.

As shown in FIG. 1, the fabric of the dielectric is wound around the first electrode 2. The fabric is fitted around the first electrode by means of a stitching thread 10. The second electrode 4 is, in this example, fitted on the fabric 9 of the dielectric 6. More in particular, it holds that the second electrode 4 consists of graphite. In this example, the graphite is arranged on both sides 12, 14 of the fabric 9. The graphite may be applied in the form of a colloidal suspension. In this example, the second electrode 4 extends in the longitudinal direction of the moisture sensor 1. The second electrode is arranged at an edge 16 of the fabric 9 of the dielectric located on the exterior of the moisture sensor. In this example, the fabric 9 therefore forms both the dielectric 6 and a ribbon-shaped carrier for the second electrode 4. The second electrode 4 is therefore of ribbon-shaped design and is directed substantially parallel to the first electrode.

The moisture sensor is therefore, in this example, entirely of ribbon-shaped design. In fact the moisture sensor has the form of a flexible thread that can be easily arranged in an area where moisture should be detected.

When moisture enters the area, it will be absorbed by the dielectric 6. The moisture thus located between the first and the second electrode forms an electrolyte and has the result that a voltage difference arises between the first and the second electrode, which can be detected in a known per se manner. On the basis of the detected voltage difference, the presence of moisture can be detected. Moreover, on the basis of the size of the short-circuit current between the first and the second electrode, a measure of the amount of moisture that is detected can be derived.

In the example of FIG. 1, it therefore holds that the second electrode has an elongated form, while the second electrode extends parallel to the first electrode. The second electrode is provided with a ribbon-shaped carrier, to which a current-conducting material in this example graphite, is applied. The ribbon-shaped carrier, in this example, consists of a part 18 of the fabric 9, which also forms the dielectric 6. A moisture sensor having such properties may, however, also be formed differently, as will be discussed with reference to FIG. 2.

In FIGS. 1 and 2, parts corresponding to each other are provided with the same reference numerals.

As regards the moisture sensor 20 of FIG. 2, it also holds that the first electrode 2 is provided with a ribbon-shaped carrier 8, to which the IGP is applied. The ribbon-shaped carrier 8, for its part, may be provided with a thread, preferably a fabric thread or a ribbon-shaped fabric to which the IGP is applied.

The second electrode 4 is, in this example, also provided with a ribbon-shaped carrier 22, to which a current-conducting material such as graphite, is applied The ribbon-shaped carrier 22, for its part, may be provided with a thread, in particular a fabric thread or a ribbon-shaped fabric. The graphite may, in a known per se manner, be applied to the ribbon-shaped carrier 22. The first and the second electrode extend parallel to each other. The dielectric 6, again, consists of a fabric, preferably a cotton fabric, wound around the first electrode 2 and the second electrode 4 such that the dielectric 6, that is to say the fabric 9, separates the first electrode 2 and the second electrode 4 from each other. The fabric is, again, firmly fitted by means of a stitching thread 10.

Even in this embodiment, it holds that the moisture sensor as such has the form of a ribbon. The operation of the moisture sensor corresponds entirely, as discussed in relation to FIG. 1.

The moisture sensor of FIGS. 1 and 2 may, for instance, be fitted in a diaper for detecting moisture in the diaper. Completely different uses are, however, also possible.

The moisture sensor may also assume other forms than those discussed for the embodiments of FIGS. 1 and 2. According to a special embodiment of the moisture sensor, it is incorporated into a diaper 24. FIG. 3 shows an embodiment thereof.

The diaper 24 of FIG. 3 is a known per se diaper, in which the known per se fluff 26 is arranged. Also arranged in the fluff 26 is a first electrode 2 of a type discussed with reference to FIGS. 1 or 2. It is, however, also possible that the first electrode 2 is fitted on a coating foil of the diaper. The first electrode is then located between the coating foil and the fluff. In this example, the first electrode 2 is fitted around an area 28 of the diaper, in which the moisture should be detected. The first electrode 2 extends in the interior of the diaper through the fluff 26. Moreover, a graphite layer 4 is arranged in the fluff 26. This graphite layer functions as second electrode 4. The fluff 26 located between the first electrode 2 and the second electrode 4 functions as the dielectric 6. When the fluff 26 located between the first and the second electrode becomes wet, a voltage difference will be generated between the first electrode 2 and the second electrode 4, which can b detected in a known per se manner and is an indication of the presence of moisture. The short-circuit current between the first and the second electrode is a measure of the amount of moisture.

With reference to FIG. 4, another use of the sensor according to the invention will be discussed. FIG. 4 diagrammatically shows a cross-section of the sensor of FIG. 2. Here, parts corresponding to each other are provided with the same reference numerals. FIG. 4 shows that the average place 30 of the moisture 32 on the sensor 1 can be determined from the ratio of the short-circuit currents I₁ and I₂, measured at the two ends 34, 36 of the sensor 2 between the first and the second electrode 4, 6. The short-circuit currents I₁ and I₂ are, in this example, measured by means of the measuring units 38 and 40, respectively. If the moisture 32 is closer to the first end 34 than to the second end 36 or the internal resistance R₁ determining the short-circuit current I₁ is smaller than the internal resistance R₂ determining the short-circuit current I₂. Anyway, this is only successful if the resistance of the first electrode (in the longitudinal direction) is not negligibly small (and, of course, not infinitely big either).

The invention is by no means limited to the above embodiments. Thus, it particularly holds that the first and the second electrode are provided with materials different from each other, in this example respectively IGP and graphite for the first and the second electrode. It is, however, also possible that the second electrode is provided with an IGP as well. This IGP is, however, another IGP than the IGP of the first electrode. In this example, cotton is used as dielectric. Other materials are also conceivable. It further holds that, in this example, the thread of the first electrode is a polyester thread. Other threads, such as cotton threads or plastic threads, are also conceivable. In this example, the IGPs comprise polypyrrole. Other IGPs may, however, also be used. In this example, the cotton of the dielectric 6 is pretreated with, for instance, a buffer solution having a pH of 4. Other pH values are, however, also conceivable. Also, other additives affecting the behavior of IGPs, doping ions and ligands may also be used.

In this example of FIG. 1, the voltage between the first and the second electrode is measured. Moreover, the current may be measured through a predetermined resistance included between the first and the second electrode. Besides, the voltage between the first and the second electrode may be measured when the predetermined resistance is included between the first and the second electrode.

In particular, the amount of moisture is measured by measuring the internal resistance between the first and the second electrode. This internal resistance may, for instance, be determined by measuring the short-circuit current between the first and the second electrode. Other known methods for determining the internal resistance can, however, also be used.

Instead of the amount of moisture, the length of the part of the moisture sensor that is wet can be determined quite analogously.

Moreover, a coating may be locally applied to an exterior of the fabric of the dielectric for designing the moisture sensor so as to be sensitive to moisture in dependence on the place thereof, preferably the moisture sensor of FIG. 1 or 2. Where the coating is lacking, the moisture sensor is sensitive to moisture.

Furthermore, the presence and/or the intactness of the moisture sensor can be detected by measuring the resistance of at least one of the electrodes, the direct-current resistance between the electrodes and/or the alternating-current resistance between the electrodes. Such variants are all deemed to fall within the scope of the invention.

1. A moisture sensor for detecting moisture, comprising at least one first electrode provided with an IGP, at least one second electrode and at least one dielectric included between the first and the second electrode, which dielectric is of a type that can absorb moisture, so that the presence of moisture can be detected on the basis of an electric voltage difference between the first and the second electrode, characterized in that the first electrode is provided with a ribbon-shaped carrier, to which the at least one IGP is applied.

2. A moisture sensor according to claim 1, characterized in that the ribbon-shaped carrier of the first electrode is provided with a thread, to which the at least one IGP is applied or a ribbon-shaped fabric, to which the at least one IGP is applied.

3. A moisture sensor according to claim 2, characterized in that the thread or the ribbon-shaped fabric of the first electrode comprises polyester.

4. A moisture sensor according to any one of the preceding claims, characterized in that the thread or the ribbon-shaped fabric of the first electrode is coated with the at least one IGP.

5. A moisture sensor according to any one of the preceding claims, characterized in that the at least one IGP comprises polypyrrole.

6. A moisture sensor according to any one of the preceding claims, characterized in that the second electrode has an elongated form, while the second electrode extends parallel to the first electrode.

7. A moisture sensor according to claim 6, characterized in that the second electrode is provided with a ribbon-shaped carrier, to which a current-conducting material is applied.

8. A moisture sensor according to any one of the preceding claims, characterized in that the moisture sensor is, at least substantially, of ribbon-shaped design.

9. A moisture sensor according to any one of the preceding claims, characterized in that the dielectric comprises a fabric.

10. A moisture sensor according to claim 9, characterized in that the fabric of the dielectric comprises cotton.

11. A moisture sensor according to claim 10, characterized in that the dielectric is treated with an acid buffer solution.

12. A moisture sensor according to any one of claims 9-11, characterized in that the fabric of the dielectric is wound around the first electrode.

13. A moisture sensor according to claim 12, characterized in that a moisture-proof coating is locally applied to an exterior of the fabric of the dielectric for designing the moisture sensor so as to be sensitive to moisture in dependence on the place thereof.

14. A moisture sensor according to any one of the preceding claims 9-13, characterized in that the second electrode is applied to the fabric of the dielectric.

15. A moisture sensor according to claims 8, 12 and 14, characterized in that the second electrode extends in a longitudinal direction of the moisture sensor.

16. A moisture sensor according to claim 15, characterized in that the second electrode is arranged at an edge of the fabric of the dielectric located on an exterior of the moisture sensor.

17. A moisture sensor according to any one of the preceding claims, characterized in that the second electrode comprises a material different from the first electrode.

18. A moisture sensor according to claim 17, characterized in that the second electrode is provided with graphite.

19. A moisture sensor according to any one of the preceding claims, characterized in that the second electrode is provided with at least one IGP different from the at least one IGP of the first electrode.

20. A diaper provided with a moisture sensor according to any one of the preceding claims.

21. A diaper provided with a moisture sensor according to any one of the preceding claims 1-5, characterized in that the first electrode extends around an area of the diaper where the presence of moisture should be detected, while the second electrode is arranged on at least part of the fluff of the diaper in the area or on the coating foil of the diaper in the area, so that the fluff of the area functions as the dielectric.

22. A diaper according to claim 21, characterized in that the second electrode comprises graphite.

23. A diaper according to claim 22, characterized in that the graphite is applied to the fluff in the form of a colloidal suspension.

24. A diaper according to claim 21, characterized in that the second electrode is provided with at least one IGP.

25. A method for detecting the presence and/or the intactness of a moisture sensor according to any one of claims 1-19, in which the resistance of the two electrodes individually, the direct-current resistance between the electrodes and/or the alternating-current resistance between the electrodes and/or the current through a predetermined resistance included between the first and the second electrode is measured.

26. A method for determining, by means of the moisture sensor according to any one of the preceding claims 1-19, the amount of moisture and/or determining the sum of the lengths of parts of the first electrode of the moisture sensor that are moist, by measuring the internal resistance between the first and the second electrode, in particular by measuring a short-circuit current between the first and the second electrode.

27. A method for determining, by means of a moisture sensor according to any one of the preceding claims 1-19, the place of the moisture on the sensor, by determining the ratio between the short-circuit currents measured respectively at two ends of the sensor between the first and the second electrode.
